(19) United States
(12) Patent Application Publication
(10) Pub. No.: US 2007/0054694 A1
(43) Pub. Date: Mar. 8, 2007

(54) Method for activating specific function in mobile communication terminal

(75) Inventor: Hyung-Chul Lee, Hwaseong-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Gyeonggi-do (KR)

(21) Appl. No.: 11/517,753

(22) Filed: Sep. 8, 2006

(30) Foreign Application Priority Data
Sep. 8, 2005 (KR) 2005-0083624

(51) Int. Cl. H04M 1/00

(52) U.S. Cl. 455/550.1

(57) ABSTRACT

A method of activating only a specific module in a mobile communication terminal having a plurality of additional modules is provided. In the method, it is checked if a first hot key is input in order to activate only the specific module. If the first hot key is input, power is supplied to a module corresponding to the first key and the module is activated. Only specific additional functions such as an MP3 player or a digital camera can be used while a communication module is inactivated. Thus, additional functions of the mobile communication terminal can be used without being restricted by time and space. In addition, the modules can be used without a SIM or UIM card in a GSM or CDMA terminal.

### PRIORITY

This application claims priority under 35 U.S.C. § 119 to an application entitled “Method for Activating Specific Function in Mobile Communication Terminal” filed in the Korean Intellectual Property Office on Sep. 8, 2005 and assigned Ser. No. 2005-83624, the contents of which are incorporated herein by reference.

### BACKGROUND OF THE INVENTION

1. Field of the Invention

The present invention relates to a method of using a function of a specific module in a mobile communication terminal, and particularly to a method of using the function of the specific module by activating only the specific module in a mobile communication terminal.

2. Description of the Related Art

Mobile communication terminals are widely used due to their portability. Manufacturers are developing mobile communication terminals with special functions, in an effort to secure more users. For example, mobile communication terminals provide various additional functions such as a phone book, a game, a short message, Internet access, e-mail, a morning call or wake up call, and so on.

Also, in hardware, peripheral devices attached or added to the mobile communication terminal are being developed. For example, peripheral devices may include an attachable or built-in digital camera module, a TV reception module for DMB (Digital Multimedia Broadcasting) reception, an MP3 module for playing MP3 files, etc.

Thus, the advanced additional function modules in a mobile communication terminal provide additional functions. For example, interests in the functions of an MP3 player using the MP3 module, a digital camera using the digital camera module and a DMB reception using TV reception module are growing with the portability of mobile communication terminal.

In the conventional art, it is possible to employ the additional function modules such as a MP3 module or a camera module only when a communication module has been activated by turning power on. Further, in some GSM (Global System for Mobile communication) or CDMA (Code Division Multiple Access) terminals, a SIM (Subscriber Identify Module) or a UIM (User Identify Module) card is required to employ the communication module as well as the additional function modules.

FIG. 1 illustrates a booting procedure using a SIM card in a mobile communication terminal according to the conventional art. Hereinafter, an example of checking a SIM card in a GSM terminal will be described.

Referring to FIG. 1, a Micro-Processor Unit (MPU) checks whether power is supplied to the terminal (booting) in step 101. If the power is supplied, the MPU proceeds to step 103 to check if the SIM card has been inserted.

If the SIM card has not been inserted, the MPU proceeds to step 109 to display a message requesting the SIM card insert on a display window and returns to step 103 to check whether the SIM card has been inserted. If the SIM card has been inserted, the MPU proceeds to step 105 to check a personal identification number (PIN).

The MPU then proceeds to step 107 to activate all functions of the terminal and ends the process.

As described above, in the conventional art, there is a time and space limitation to the use of additional function modules since the additional function modules such as the MP3 player and the digital camera cannot be used while a communication module is not activated. In addition, in some GSM or CDMA terminals, the communication module as well as the additional function modules such as the MP3 player and the digital camera cannot be used without a SIM (Subscriber Identify Module) or a UIM (User Identify Module) card.

### SUMMARY OF THE INVENTION

Accordingly, an object of the present invention is to provide a method for employing only a specific module in a mobile communication terminal.

Another object of the present invention is to provide a method for activating additional functions without a SIM (Subscriber Identify Module) or a UIM (User Identify Module) card.

According to one aspect of the present invention for achieving the above objects, a method for activating a specific module in a mobile communication terminal having a plurality of additional modules, includes: checking whether a first hot key is pressed to activate only the specific module, and activating the specific module by supplying power to the module corresponding to the first hot key if the first hot key is pressed.

According to another aspect of the present invention for achieving the above objects, a method for activating a specific module in a GSM (Global System for Mobile Communication) terminal and a CDMA terminal, such as GSM and CDMA terminal bound for China, having a plurality of additional modules, includes: checking whether a first hot key is pressed to activate only the specific module, and activating the specific module by supplying power to the module corresponding to the first hot key, without checking for the presence of a SIM (Subscriber Identify Module) or a UIM (User Identify Module), if the first hot key is pressed.

### BRIEF DESCRIPTION OF THE DRAWINGS

The above and other objects, features, and advantages of the present invention will become more apparent from the following detailed description when taken in conjunction with the accompanying drawings in which:

FIG. 1 is a flowchart illustrating a booting procedure using a SIM card in a mobile communication terminal according to the conventional art;

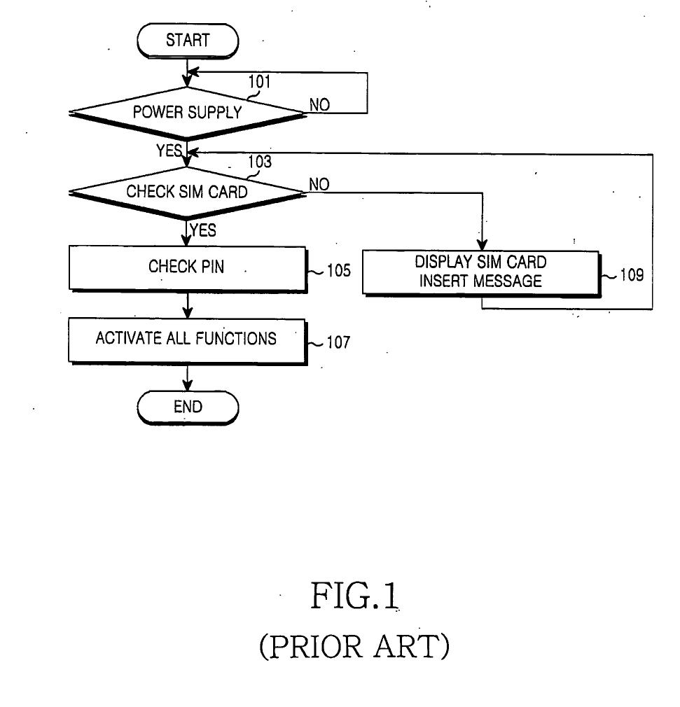

FIG. 2 is a block diagram of a mobile communication terminal according to the present invention;

FIG. 3 is a flowchart illustrating a procedure for activating a specific module in a mobile communication terminal according to a first embodiment of the present invention;

FIG. 4 is a flowchart illustrating a procedure for activating a specific module in a mobile communication terminal according to a second embodiment of the present invention; and

FIG. 5 is a flowchart illustrating a procedure for activating a specific module in a mobile communication terminal according to a third embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

Hereinafter, the present invention will be described with reference to a technology for activating only a specific module in a mobile communication terminal. Communication module functions include the functions of a call service, an SMS (Short Message Service) message, Internet access, e-mail, and so on. The specific module may be activated by using a hot key or a specific button. In at least one embodiment of the present invention, the specific module will be activated by using a hot key.

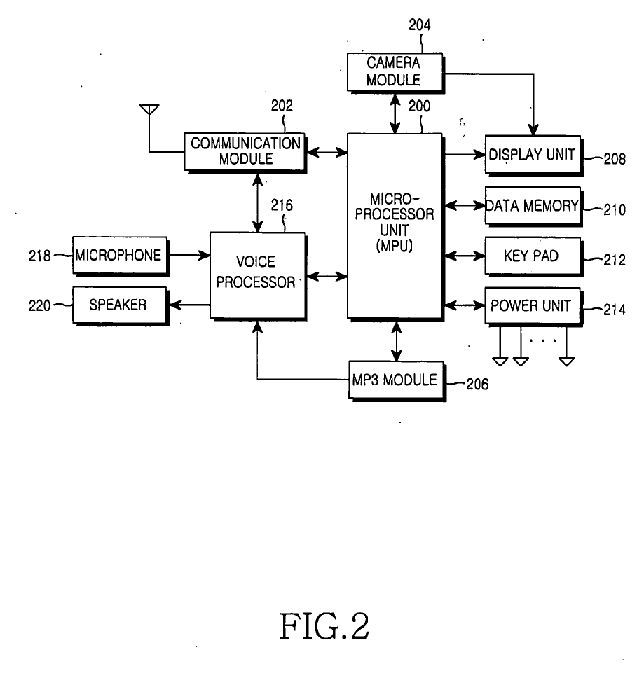

FIG. 2 is a block diagram of a mobile communication terminal according to the present invention. The mobile communication terminal may include a Personal Communication System (PCS), a Personal Data Assistant (PDA), an IMT2000 (International Mobile Telecommunication-2000) terminal and the like. Hereinafter, an explanation will be made with regard to the general configuration of these examples.

Referring to FIG. 2, a Micro-Processor Unit (MPU) 200 controls an overall operation of the portable terminal. For example, the MPU 200 is responsible for processing and controlling voice communication and data communication. In addition to such typical functions, the MPU 200 performs a function for activating only a specific module by using a hot key corresponding to the specific module. A detailed description of the typical processing and controlling operation of the MPU 200 will be omitted.

A communication module 202 transmits and receives a wireless signal of communication data through an antenna. For example, in the case of transmitting data, the communication module 202 performs channel coding and spreading data to be transmitted, and then RF processes and transmits the data. In the case of receiving data, the communication module 202 converts an RF signal received to a baseband signal, and performs de-spreading and channel decoding the baseband signal.

A camera module 204 converts image data to digital data, acquires still images by stilling the digital data, and outputs the data to a display unit 208. The display unit 208 displays information provided from the MPU 200 and image signals provided from the camera module 204.

A key pad 212 includes numeric keys of digits 0 to 9 and a plurality of function keys such as a MENU key, a CANCEL (REMOVE) key, an ENTER key, a TALK key, an END key, an Internet connection key and navigation keys (▴/▾/ [symbol] / [symbol] ). If a user presses a key, the key input data corresponding to the pressed key is transmitted to the MPU 200.

A data memory 210 temporarily stores information processed from the MPU 200 and various updatable data to be kept, such as a phone book, outgoing messages or incoming messages.

A power unit 214 supplies power to operate the functions of a mobile communication terminal. Further, in the present invention, the power unit 214 supplies power only to a specific module according to a hot key corresponding to the specific module.

A MP3 module 206 stores MP3 files and plays audio signals using the stored MP3 files. A voice processor 216, such as a CODEC, performs the function for input/output processing of analog audio signals through a microphone 218 and a speaker 220. For example, the MPU 200 produces pulse code modulation (PCM) data, and the CODEC 216 converts the PCM data into analog audio signals. The analog audio signals are output through the speaker 218. Also, the CODEC 216 converts analog audio signals received through the microphone 218 into PCM data and provides the PCM data to the MPU 200.

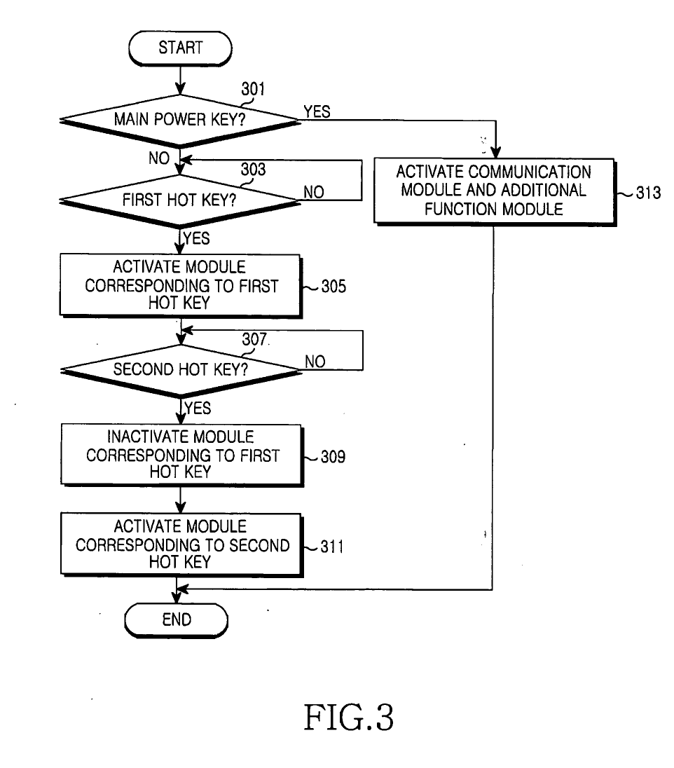

FIG. 3 is a flowchart illustrating a procedure for activating a specific module in a mobile communication terminal according to a first embodiment of the present invention.

Referring to FIG. 3, the MPU 200 checks whether a power key is pressed by a user in step 301. If the power key is pressed, the MPU 200 proceeds to step 313 to activate a communication module 202 and additional modules (e.g., MP3 module 206 and camera module 204) and ends the process.

If the power key is not pressed, the MPU 200 proceeds to step 303 to check whether a first hot key (e.g., a camera hot key, an MP3 hot key or a TV hot key) is pressed by a user.

If the first hot key is pressed, the MPU 200 proceeds to step 305 to activate the module corresponding to the first hot key. That is, the power unit 214 supplies power only to the module corresponding to the first hot key. For example, if the first hot key is a digital camera hot key, the MPU 200 activates the camera module, and if the first hot key is an MP3 hot key, the MPU 200 activates the MP3 module.

The MPU 200 then proceeds to step 307 to check whether a second hot key is pressed while the module corresponding to the first hot key is activated. If the second hot key is pressed, the MPU 200 proceeds to step 309 to inactivate the module corresponding to the first hot key, and then the MPU 200 activates the module corresponding to the second hot key in step 311. That is, the power unit 214 cuts the supply of power to the module corresponding to the first hot key and then supplies power to the module corresponding to the second hot key. For example, in the case where the module corresponding to the first hot key is an MP3 module and the module corresponding to the second hot key is a camera module, if the camera hot key is pressed by a user while the MP3 module is activated, the MP3 module is inactivated and the camera module is then activated. Then, the MPU 200 ends the process.

FIG. 3 shows that in order to activate the second module while the first module is activated, the MPU 200 inactivates the first module and then activates the second module. Otherwise, when the first module is activated, other modules are inactivated. In other words, to activate the second module, the first module is inactivated and the second module is then activated.

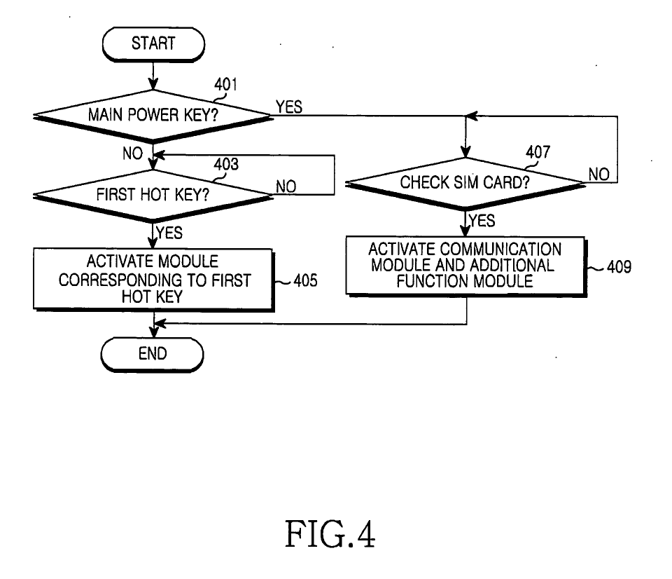

FIG. 4 is a flowchart illustrating a procedure for activating a specific module in a mobile communication terminal according to a second embodiment of the present invention. Upon booting a GSM (Global System for Mobile Communication) terminal or a CDMA (Code Division Multiple Access) terminal bound for China, a SIM (Subscriber Identify Module) or a UIM(User Identify Module) card is checked. Hereinafter, an example of checking the SIM card in the GSM terminal will be described.

Referring to FIG. 4, the MPU 200 checks whether a power key is pressed by a user. If the power key is pressed, the MPU 200 proceeds to step 407 to check whether a SIM card has been inserted. If the SIM card has been inserted, the MPU 200 checks a personal identification number of the SIM card and activates a communication module 202 and additional function modules (e.g., camera module 204 and MP3 module 206). The MPU 200 then ends the process.

If the power key is not pressed, the MPU 200 proceeds to step 403 to check whether a first hot key (e.g., an MP3 hot key, a camera hot key or a TV hot key) is pressed by a user. If the first hot key is pressed, the MPU 200 proceeds to step 405 to activate the module corresponding to the first hot key without checking for the presence of the SIM card. That is, the power unit 214 supplies power only to the module corresponding to the first hot key. The MPU 200 then ends the process.

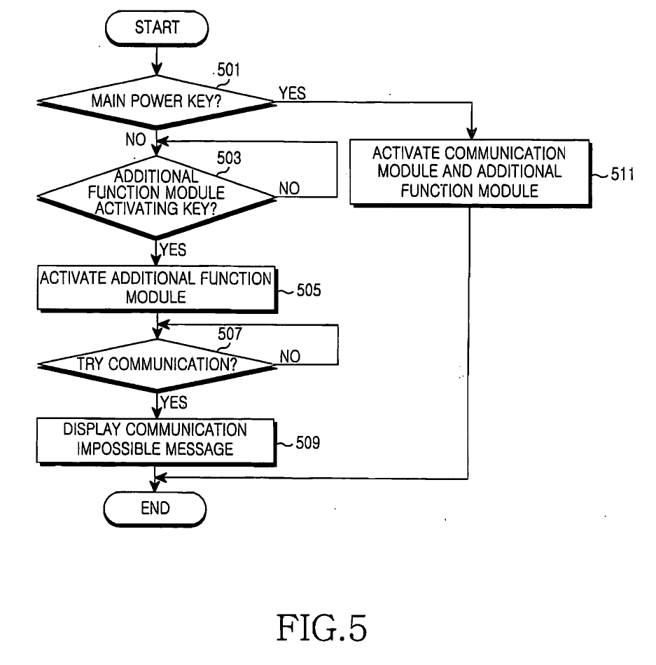

FIG. 5 is a flowchart illustrating a procedure for activating a specific module in a mobile communication terminal according to a third embodiment of the present invention.

Referring to FIG. 5, the MPU 200 checks whether a power key is pressed by a user in step 501. If the power key is pressed, the MPU 200 proceeds to step 511 to activate a communication module 202 and additional modules (e.g., camera module 204 and MP3 module 206). The MPU 200 then ends the process.

If the power key is not pressed, the MPU 200 proceeds to step 503 to check whether a key for activating additional modules is pressed by a user. If the key for activating additional function modules is pressed, the MPU 200 activates the additional modules (e.g., MP3 module 206 and camera module 204) except for the communication module 202 in step 505. That is, the power unit 214 supplies power only to the additional modules.

After this, the MPU 200 proceeds to step 507 to check whether a user tries to communicate by key manipulation. If there is an attempt to communicate by the user, the MPU 200 proceeds to step 509 to display a message that “Communication Is Impossible” on the display unit 208. That is, the user is notified that the communication module 202 is inactivated. The MPU 200 then ends the process.

In the case where only a specific module is activated, if the use of the specific module is terminated, the terminal does not transition to a waiting state but the power of the specific module is turned off.

As described above, a specific module may be activated by using a hot key or a specific button in a mobile communication terminal. Thus, only a specific additional function such as an MP3 player or a digital camera can be used while a communication module is not activated. Accordingly, additional finctions of a mobile communication terminal can be used without time and space restrictions. In addition, additional functions of a mobile communication terminal can be used without a SIM or a UIM card in a GSM or CDMA terminal.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for activating a specific module in a mobile communication terminal having a plurality of additional modules, comprising the steps of:
checking whether a first hot key is pressed to activate the specific module; and
activating the specific module by supplying power to a module corresponding to the first hot key if the first hot key is pressed.

2. The method of claim 1, wherein the plurality of additional modules include an MP3 (MPEG Audio Layer-3) module, a camera module and a TV (Television) reception module.

3. The method of claim 1, further comprising:
checking whether a second hot key is pressed while the module corresponding to the first hot key is activated;
inactivating the first module by cutting power supply to the module corresponding to the first hot key if the second hot key is pressed; and
activating a second module by supplying power only to the module corresponding to the second hot key.

4. The method of claim 1, further comprising blocking input of the second hot key while the module corresponding to the first hot key is activated.

5. A method for activating a specific module in a mobile communication terminal having a plurality of additional modules, comprising the steps of:
checking whether a key for activating additional modules is pressed to activate only the additional modules; and
activating the additional modules by supplying power only to the additional modules if the key for activating the additional modules is pressed.

6. The method of claim 5, wherein the plurality of additional modules include an MP3 (MPEG Audio Layer-3) module, a camera module and a TV (Television) reception module.

7. The method of claim 5, wherein a communication module is in an inactive state while the additional modules are activated.

8. The method of claim 7, further comprising displaying a message that communication is impossible when there is an attempt to employ a communication module by a user.

9. A method for activating a specific module in a GSM (Global System for Mobile communication) terminal and CDMA (Code Division Multiple Access) terminal having a plurality of additional modules, comprising the steps of:
checking whether a first hot key is pressed to activate only a specific module; and
activating the first module by supplying power only to a module corresponding to the first hot key, without checking for the presence of a SIM (Subscriber Identify Mobile) or a UIM (User Identify Module) card, if the first hot key is pressed.

10. The method of claim 9, further comprising checking for the presence of a SIM (Subscriber Identify Mobile) or a UIM (User Identify Module) card, if a power key is pressed.

11. The method of claim 9, wherein the plurality of additional modules include an MP3 (MPEG Audio Layer-3) module, a camera module and a TV (Television) reception module.

12. The method of claim 9, further comprising:
checking whether a second hot key is pressed while only a module corresponding to the first hot key is activated;
inactivating the first module by cutting power supply of the module corresponding to the first hot key if the second hot key is pressed; and
activating the second module by supplying power only to a module corresponding to the second hot key.

13. The method of claim 9, further comprising blocking input of the second hot key while only the module corresponding to the first hot key is activated.
